(19) United States
(12) Patent Application Publication
(10) Pub. No.: US 2024/0326775 A1
(43) Pub. Date: Oct. 3, 2024

(54) Method and Device for Operating an On-Board Electrical System for a Hybrid Drive

(71) Applicant: Bayerische Motoren Werke AKtiengesellschaft, Muenchen (DE)

(72) Inventor: Stanko GRADEV, Muenchen (DE)

(21) Appl. No.: 18/294,230

(22) PCT Filed: Jul. 26, 2022
(86) PCT No.: PCT/EP2022/070939

§ 371 Date: Feb. 1, 2024

(30) Foreign Application Priority Data
Aug. 2, 2021 (DE) 10 2021 119 954.9

(51) Int. Cl. B60W 10/26

(52) U.S. Cl. CPC B60W 10/26; B60W 2510/0676; B60W 2510/244

(57) ABSTRACT

A device for operating an on-board electrical system including a first subsystem with a first energy storage device and an electric machine and a second subsystem with a second energy storage device, wherein the electric machine is part of a hybrid drive starts an internal combustion engine, wherein the device determines whether the electric machine has to be operated in order to start the internal combustion engine for subsequently starting the hybrid drive and, in preparation for subsequently starting the hybrid drive, cause electrical energy to be transferred from the second energy storage device to the first energy storage device when it is determined that the electrical machine has to be operated in order to start the internal combustion engine for subsequently starting the hybrid drive.

### BACKGROUND AND SUMMARY

The invention relates to a method and a corresponding device for operating an on-board electrical system for a hybrid drive, in particular for starting the internal combustion engine of the hybrid drive.

A vehicle may have a hybrid drive with an internal combustion engine and an electrical machine which can both be used to drive the vehicle. The electrical machine may also be used to recuperate electrical energy during decelerations of the vehicle.

The vehicle also has an on-board electrical system having a first energy store for storing electrical energy which can be used to operate the electrical machine and/or which has been recuperated by the electrical machine. The first energy store may be arranged in a first subsystem of the on-board system, wherein the first subsystem has a first nominal voltage (for example 48 V or higher).

The on-board electrical system may also comprise a second subsystem having a second nominal voltage which is typically less than the first nominal voltage. The second nominal voltage may be 12 V, for example. The second subsystem may have a second energy store which is used, in particular, to support the voltage in the second subsystem and/or to supply electrical loads in the second subsystem with power.

The present document deals with the technical object of making it possible to operate a vehicle with a hybrid drive in the most energy-efficient manner possible.

The object is achieved according to the present disclosure. Advantageous embodiments are also described in the present disclosure. It is pointed out that additional features of a patent claim dependent on an independent patent claim can form, without the features of the independent patent claim or only in combination with a subset of the features of the independent patent claim, a separate invention which is independent of the combination of all features of the independent patent claim and can be made into the subject matter of an independent claim, a divisional application or a subsequent application. This applies in the same manner to technical teachings which are described in the description and can form an invention independent of the features of the independent patent claims.

One aspect describes a device for operating an on-board electrical system. The on-board electrical system may be part of a motor vehicle. The on-board electrical system comprises a first subsystem with a first electrical energy store (in particular with an electrochemical energy store, for example a lithium-ion store) and with an electrical machine (in particular with an electric motor). The on-board system also comprises a second subsystem with a second energy store (in particular with an electrochemical energy store, for instance a lithium-ion store or a lead accumulator).

The on-board system may also comprise a DC/DC converter which is configured to transfer electrical energy from the second subsystem to the first subsystem. In this case, the first subsystem may have a first nominal voltage and the second subsystem may have a different, second nominal voltage, wherein the second nominal voltage is typically less than the first nominal voltage. The first nominal voltage may be, for example, 48 V or more or 300 V or more. The second nominal voltage may be 18 V or less, in particular 12 V.

The electrical machine is part of a hybrid drive (for example a hybrid drive for a motor vehicle). The electrical machine is also designed to start the internal combustion engine (for example a gasoline engine) of the hybrid drive. In particular, the electrical machine can be used to effect a cold start of the internal combustion engine (at temperatures which are equal to or less than a temperature threshold value).

The device may be configured to determine whether the electrical machine must be operated in order to start the internal combustion engine for subsequently starting the hybrid drive (for example whether a cold start of the internal combustion engine must be effected). The device may be configured, in particular, to determine, during a switch-off process of the hybrid drive (that is to say while the hybrid drive is being switched off or stopped) and/or while the hybrid drive is switched off, whether the electrical machine must be operated in order to start the internal combustion engine for subsequently starting the hybrid drive (directly after the switch-off process).

For this purpose, the device may be configured to determine temperature data relating to the temperature of the internal combustion engine and/or relating to the temperature of the (direct) environment of the internal combustion engine. The temperature data may be determined using a temperature sensor of the hybrid drive and/or of the vehicle. The temperature data may be determined during the switch-off process of the hybrid drive and/or while the hybrid drive is switched off.

It is then possible to reliably determine, on the basis of the temperature data, whether the electrical machine must be operated in order to start the internal combustion engine for subsequently starting the hybrid drive. For this purpose, the temperature indicated by the temperature data can be compared with the temperature threshold value.

The device is also configured to cause electrical energy to be transferred from the second energy store to the first energy store in preparation for subsequently starting the hybrid drive if it is determined that the electrical machine must be operated in order to start the internal combustion engine for subsequently starting the hybrid drive. In particular, the DC/DC converter of the on-board system may be prompted to transfer electrical energy from the second energy store to the first energy store in preparation for subsequently starting the hybrid drive. The transfer may be carried out during the switch-off process of the hybrid drive and/or while the hybrid drive is switched off.

A description is therefore given of a device which is configured to transfer electrical energy to the first energy store of the on-board system if necessary (during a switch-off process of the hybrid drive and/or while the hybrid drive is switched off, that is to say outside the operation of the hybrid drive) in preparation for a cold start. This makes it possible to use the first electrical energy store completely for the cyclical removal and reception (recuperation) of electrical energy during operation of the hybrid drive. The energy efficiency of the hybrid drive can therefore be increased in an efficient and reliable manner.

The device may be configured to determine, on the basis of the temperature data, that the temperature of the internal combustion engine and/or the temperature of the environment of the internal combustion engine is/are less than or equal to the temperature threshold value (for example 10° C. or less or 0° C. or less). It can then be determined, on the basis thereof, that the electrical machine must be operated in order to start the internal combustion engine for subsequently starting the hybrid drive. In particular, in response to this, it is possible to cause electrical energy to be transferred from the second energy store to the first energy store in preparation for subsequently starting the hybrid drive. The on-board system and/or the hybrid drive can therefore be operated in a particularly efficient and reliable manner.

The device may be designed to determine an amount of energy which, starting from the actual state of charge of the first energy store, is still needed to operate the electrical machine for starting the internal combustion engine. It is then possible to cause (only) the determined amount of energy to be transferred from the second energy store to the first energy store in preparation for subsequently starting the hybrid drive. It is therefore possible to cause only precisely the amount of energy required for a subsequent cold start to be transferred. The energy efficiency of the hybrid drive can therefore be increased further.

A further aspect describes a (road) motor vehicle (in particular an automobile or a truck or a bus) which comprises the device described in this document. The motor vehicle may be a hybrid vehicle, in particular an MHEV (Mild-Hybrid Electric Vehicle).

The vehicle also comprises a hybrid drive with an internal combustion engine and an electrical machine, wherein the electrical machine is designed to start the internal combustion engine. The vehicle also comprises an on-board electrical system which has a first subsystem with a first energy store and with the electrical machine and a second subsystem with a second energy store.

In addition, the vehicle does not have a separate starter for starting the internal combustion engine, in particular in the second subsystem. As a result of the (energy-efficient) use of the electrical machine as the starter, it is therefore possible to dispense with a second starter (in the second subsystem). The costs, the weight and the required space of the vehicle can therefore be reduced.

A further aspect describes a method for operating an on-board electrical system which comprises a first subsystem with a first energy store and with an electrical machine and a second subsystem with a second energy store. The electrical machine is part of a hybrid drive and is designed to start the internal combustion engine of the hybrid drive.

The method comprises determining whether the electrical machine must be operated in order to start the internal combustion engine for subsequently starting the hybrid drive. The method also comprises causing electrical energy to be transferred from the second energy store to the first energy store in preparation for subsequently starting the hybrid drive if it is determined that the electrical machine must be operated in order to start the internal combustion engine for subsequently starting the hybrid drive.

A further aspect describes a software (SW) program. The SW program may be configured to be executed on a processor (for example on a control unit of a vehicle) and to thereby carry out the method described in this document.

A further aspect describes a storage medium. The storage medium may comprise a SW program which is configured to be executed on a processor and to thereby carry out the method described in this document.

It should be noted that the methods, devices and systems described in this document can be used both alone and in combination with other methods, devices and systems described in this document. Furthermore, any aspects of the methods, devices and systems described in this document can be combined with one another in various ways. In particular, the features of the claims can be combined with one another in various ways.

The invention is described in more detail below using exemplary embodiments.

### BRIEF DESCRIPTION OF THE DRAWINGS

FIG. 1 shows an exemplary vehicle with a hybrid drive;

FIG. 2 shows an exemplary on-board electrical system for a vehicle with a hybrid drive; and

FIG. 3 shows a flowchart of an exemplary method for operating an on-board electrical system.

### DETAILED DESCRIPTION OF THE DRAWINGS

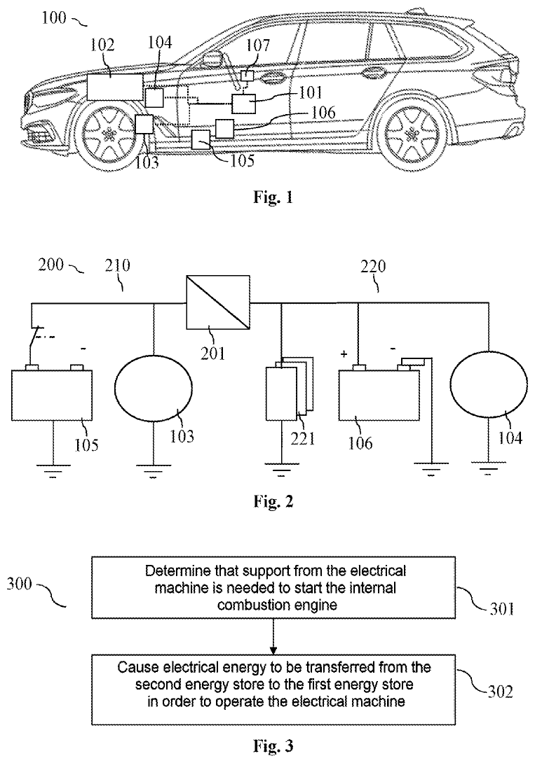

As explained at the outset, the present document deals with increasing the energy efficiency of a vehicle with a hybrid drive. In this context, FIG. 1 shows an exemplary vehicle 100 having an internal combustion engine 102 and an electrical machine 103 which are both designed to drive the vehicle 100. The vehicle 100 may have an electrically operated pinion starter 104 which is designed to start the internal combustion engine 102. The vehicle 100 may also have (as part of the first subsystem of the on-board electrical system of the vehicle 100) a first electrical energy store 105 which is configured to store electrical energy for operating the electrical machine 103 and/or which is configured to store electrical energy recuperated by the electrical machine 103.

The vehicle 100 may also have a second electrical energy store 106 (as part of the second subsystem of the on-board electrical system of the vehicle 100) which is configured to store electrical energy for one or more electrical loads of the vehicle 100, in particular for the pinion starter 104.

The vehicle 100 also comprises a (control) device 101 which is configured to control the different components of the vehicle 100, for example the internal combustion engine 102, the electrical machine 103, the pinion starter 104, etc.

FIG. 2 shows an exemplary on-board electrical system 200 of a vehicle 100, having a first subsystem 210 (which is operated with a first nominal voltage, for example 48 V or more) and having a second subsystem 220 (which is operated with a second nominal voltage, for example 12 V or less). The first energy store 105 and the electrical machine 103 may be arranged in the first subsystem 210. The second energy store 106, the optional pinion starter 104 and one or more further electrical loads 221 (for example a seat heating system, an air conditioning system, an infotainment system) may be arranged in the second subsystem 220.

The on-board system 200 may have a DC/DC converter 201 which is configured to transfer electrical energy from the first subsystem 210 to the second subsystem 220 and/or from the second subsystem 220 to the first subsystem 210.

The electrical (drive) machine 103 of the hybrid drive can be used as the starter for the internal combustion engine 102 of the hybrid drive. This has the advantage that the pinion starter 104 may possibly be dispensed with, thus being able to reduce costs, weight and space. On the other hand, a certain energy reserve must typically be provided in this case in the first energy store 105 for operating the electrical machine 103 as a starter for the internal combustion engine 102, in particular in winter for a cold start of the internal combustion engine 102. As a result of the constantly held energy reserve, the remaining capacity of the first energy store 105, which can be cycled during operation of the hybrid drive in order to repeatedly recuperate electrical energy and to consume it for driving the vehicle 100, falls. In other words, the use of the electrical machine 103 as a starter for the internal combustion engine 102 typically results in a reduced energy efficiency of the hybrid drive.

The (control) device of the vehicle 100 may be configured to use at least part of the electrical energy stored in the second energy store 106 to operate the electrical machine 103 for starting the internal combustion engine 102 if necessary. This makes it possible to dispense with a constantly held energy reserve in the first energy store 105, with the result that an increased capacity of the first energy store 105 is available for cyclization during operation of the hybrid drive. The energy efficiency of the hybrid drive can therefore be increased, in particular in winter.

The (control) device 101 may be configured to determine temperature data from a temperature sensor 107 of the vehicle 100, wherein the temperature sensor 107 is designed to capture temperature data relating to the ambient temperature of the vehicle 100 and/or relating to the temperature of the internal combustion engine 102. The device 101 may also be configured to determine, on the basis of the temperature data, whether or not it is necessary to operate the electrical machine 103 for (cold) starting the internal combustion engine 102. This may be checked, for example, when switching off the vehicle 100 and/or during a process of parking the vehicle 100.

If it is determined that the electrical machine 103 is needed to (subsequently) start the internal combustion engine 102, electrical energy can be transferred from the second energy store 106 to the first energy store 105 if necessary via the DC/DC converter 201 in order to ensure that sufficient electrical energy for operating the electrical machine 103 for starting the internal combustion engine 102 is stored in the first energy store 105. The electrical energy can be transferred without and/or before a specific request for starting the hybrid drive and/or the internal combustion engine 102.

In order to enable a cold start from the first subsystem 210 (for example a 48 V cold start) and/or a switching capability from the first subsystem 210 (for example a 48 V switching capability), recharging from the second energy store 106 (for example from the 12 V battery) into the first energy store 105 (for example into the 48 V battery) can therefore be carried out. This can be carried out, for example, when switching off the vehicle 100 at relatively cold temperatures (for example if the measured temperature is less than or equal to a temperature threshold value).

In order to intercept an unexpected temperature drop, the device 101 may be configured (during a parking process) to wake up the vehicle 100 if the temperature threshold value is undershot in order to recharge the first energy store 105 from the second energy store 106.

A cold start of the hybrid drive can therefore be enabled in an efficient and reliable manner (even if there is no pinion starter 104). The energy efficiency of the hybrid drive can thus also be increased.

FIG. 3 shows a flowchart of a (possibly computer-implemented) method 300 for operating an on-board electrical system 200. The on-board electrical system 200 comprises a first subsystem 210 with a first electrical energy store 105 (for example a lithium-ion-based store) and with an electrical machine 103. The on-board system 200 also comprises a second subsystem 220 with a second electrical energy store 106 (for example with a lead accumulator or with a lithium-ion-based store). The second nominal voltage of the second electrical energy store 106 is typically less than the first nominal voltage of the first electrical energy store 105.

The electrical (drive) machine 103 is part of a hybrid drive and is designed to start the internal combustion engine 102 (for example a gasoline engine) of the hybrid drive. In particular, the electrical machine 103 can be used for a cold start of the internal combustion engine 102 (at temperatures below a certain temperature threshold value).

The method 300 comprises determining 301 whether the electrical machine 103 must be operated in order to start the internal combustion engine 102 for subsequently starting the hybrid drive. For example, it is possible to identify, when switching off the hybrid drive or while the hybrid drive is switched off, that the temperature is so low that presumably it will be necessary to support the electrical machine 103 for starting the internal combustion engine 102.

The method 300 also comprises causing 302 electrical energy to be transferred from the second energy store 106 to the first energy store 105 in preparation for subsequently starting the hybrid drive when (in particular only when) it is determined that the electrical machine 103 must be operated in order to start the internal combustion engine 102 for subsequently starting the hybrid drive. Electrical energy can therefore be selectively transferred from the second energy store 106 to the first energy store 105 (while the hybrid drive is being switched off or is switched off). The transfer can be carried out temporally before and/or independently of a specific request to start the hybrid drive and/or the internal combustion engine 102. A subsequent cold start of the hybrid drive can therefore be prepared for in an efficient and reliable manner.

The present invention is not restricted to the exemplary embodiments shown. In particular, it should be noted that the description and the figures are intended to illustrate only by way of example the principle of the proposed methods, devices and systems.

1-10. (canceled)

11. A device for operating an on-board electrical system, wherein the on-board electrical system comprises a first subsystem with a first energy store and an electrical machine, and a second subsystem with a second energy store, wherein the electrical machine is part of a hybrid drive and is configured to start an internal combustion engine of the hybrid drive, wherein the device is configured to:
determine whether the electrical machine must be operated in order to start the internal combustion engine for subsequently starting the hybrid drive; and
cause electrical energy to be transferred from the second energy store to the first energy store in preparation for subsequently starting the hybrid drive in response to determining that the electrical machine must be operated in order to start the internal combustion engine for subsequently starting the hybrid drive.

12. The device according to claim 11, wherein the device is configured to:
determine temperature data relating to a temperature of the internal combustion engine and/or relating to a temperature of an environment of the internal combustion engine; and
determine, on a basis of the temperature data, whether the electrical machine must be operated in order to start the internal combustion engine for subsequently starting the hybrid drive.

13. The device according to claim 12, wherein the device is configured to:
determine, on the basis of the temperature data, that the temperature of the internal combustion engine and/or of the environment of the internal combustion engine is less than or equal to a temperature threshold value; and
responsively cause the electrical energy to be transferred from the second energy store to the first energy store in preparation for subsequently starting the hybrid drive.

14. The device according to claim 11, wherein the device is configured to, during a switch-off process of the hybrid drive and/or while the hybrid drive is switched off:
determine whether the electrical machine must be operated in order to start the internal combustion engine for subsequently starting the hybrid drive; and/or
cause the electrical energy to be transferred from the second energy store to the first energy store in preparation for subsequently starting the hybrid drive.

15. The device according to claim 11, wherein
the on-board system comprises a DC/DC converter configured to transfer electrical energy from the second subsystem to the first subsystem, and
wherein the device is configured to:
cause the DC/DC converter to transfer the electrical energy from the second energy store to the first energy store in preparation for subsequently starting the hybrid drive.

16. The device according to claim 11, wherein
the first subsystem has a first nominal voltage of 48 V or more, and/or
wherein the second subsystem has a second nominal voltage of 18 V or less; and/or
wherein the hybrid drive is in the form of a drive of a motor vehicle.

17. The device according to claim 11, wherein the device is configured to:
determine an amount of energy which, starting from an actual state of charge of the first energy store, is still needed to operate the electrical machine for starting the internal combustion engine; and
cause the determined amount of energy to be transferred from the second energy store to the first energy store in preparation for subsequently starting the hybrid drive.

18. A vehicle comprising:
a hybrid drive with an internal combustion engine and an electrical machine, wherein the electrical machine is designed to start the internal combustion engine;
an on-board electrical system comprising a first subsystem with a first energy store and the electrical machine, and a second subsystem with a second energy store; and
the device according to claim 11.

19. The vehicle according to claim 18, wherein the vehicle does not have a separate starter for starting the internal combustion engine in the second subsystem.

20. A method for operating an on-board electrical system, the on-board electrical system comprising a first subsystem with a first energy store and an electrical machine, and a second subsystem with a second energy store, wherein the electrical machine is part of a hybrid drive and is configured to start an internal combustion engine of the hybrid drive, the method comprising:
determining whether the electrical machine must be operated in order to start the internal combustion engine for subsequently starting the hybrid drive; and
causing electrical energy to be transferred from the second energy store to the first energy store in preparation for subsequently starting the hybrid drive in response to determining that the electrical machine must be operated in order to start the internal combustion engine for subsequently starting the hybrid drive.

21. The method according to claim 20, comprising:
determining temperature data relating to a temperature of the internal combustion engine and/or relating to a temperature of an environment of the internal combustion engine; and
determining, on a basis of the temperature data, whether the electrical machine must be operated in order to start the internal combustion engine for subsequently starting the hybrid drive.

22. The method according to claim 21, comprising:
determining, on the basis of the temperature data, that the temperature of the internal combustion engine and/or of the environment of the internal combustion engine is less than or equal to a temperature threshold value; and
responsively causing the electrical energy to be transferred from the second energy store to the first energy store in preparation for subsequently starting the hybrid drive.

23. The method according to claim 20, comprising:
during a switch-off process of the hybrid drive and/or while the hybrid drive is switched off:
determining whether the electrical machine must be operated in order to start the internal combustion engine for subsequently starting the hybrid drive; and/or
causing the electrical energy to be transferred from the second energy store to the first energy store in preparation for subsequently starting the hybrid drive.

24. The method according to claim 20, wherein
the on-board system comprises a DC/DC converter configured to transfer electrical energy from the second subsystem to the first subsystem,
the method comprising:
causing the DC/DC converter to transfer the electrical energy from the second energy store to the first energy store in preparation for subsequently starting the hybrid drive.

25. The method according to claim 20, wherein
the first subsystem has a first nominal voltage of 48 V or more, and/or
wherein the second subsystem has a second nominal voltage of 18 V or less; and/or
wherein the hybrid drive is in the form of a drive of a motor vehicle.

26. The method according to claim 20, comprising:
determining an amount of energy which, starting from an actual state of charge of the first energy store, is still needed to operate the electrical machine for starting the internal combustion engine; and
causing the determined amount of energy to be transferred from the second energy store to the first energy store in preparation for subsequently starting the hybrid drive.
